(19) United States
(12) Patent Application Publication
(10) Pub. No.: US 2015/0065048 A1
(43) Pub. Date: Mar. 5, 2015

(54) WIRELESS COMMUNICATION KEYBOARD AND METHOD FOR ESTABLISHING LINKAGE THEREOF

(71) Applicant: Zippy Technology Corp., New Taipei City (TW)

(72) Inventor: Szu-Wei Sun, Pingzhen City (TW)

(73) Assignee: Zippy Technology Corp., New Taipei City (TW)

(21) Appl. No.: 14/019,389

(22) Filed: Sep. 5, 2013

(51) Int. Cl. G06F 3/02; H04B 7/26

(52) U.S. Cl. CPC G06F 3/0227; H04B 7/26
USPC 455/41.2

(57) ABSTRACT

A wireless communication keyboard includes a key module and a wireless communication module. The key module has a plurality of keys each can be depressed by a user to output a keyboard command. The key module also has a press combination including at least two keys which are depressed by the user at the same time to output a target search command. The wireless communication module is connected to the key module to receive the keyboard command and target search command, and has a linkage target setting state to search a linkable information device within a linkage range upon receiving the target search command. Thus user can quickly search the linkable information device through the press combination.

### FIELD OF THE INVENTION

The present invention relates to a keyboard and particularly to a wireless communication keyboard and a method for establishing linkage thereof to search a linkable information device through a press combination.

### BACKGROUND OF THE INVENTION

When the computer was at a well developed stage keyboard had become a necessary basic output facility. While personal computers have progressed rapidly, the keyboard largely maintains its original style. With improvements of keyboard material and structure, the size and weight of the keyboard have been greatly reduced. Even foldable and extendable composite keyboards, and rollable and bendable flexible keyboards are now available on the market that make keyboards become portable computer accessories. However, signal cable connection between the conventional keyboard and computer system is the main constraint that limits use flexibility of the keyboard. The length limitation of the signal cable also restricts use distance and environment.

The main wireless technique adopted in earlier keyboard was infrared ray. But the infrared ray has constraints on connection such as distance, angle and obstacles that tend to generate signal errors. Hence in recent years Bluetooth technique has been adopted in the wireless keyboard to improve the shortcomings of infrared ray in implementation. At present, the wireless keyboard incorporated with Bluetooth technique generally has an independent linkage target search key on the keyboard. Before a user sets a Bluetooth linkage target, the linkage target search key is pressed to enter a linkage setting mode. The linkage target search key generally is located at the bottom side of the keyboard. Hence user has to flip the keyboard upside down to press the linkage target search key to enter the linkage setting mode before setting. Thus user cannot quickly do the setting of the linkage target. Moreover, the keyboard structure needs additional design to accommodate the linkage target search key that creates adverse concerns in fabrication and cost.

### SUMMARY OF THE INVENTION

The primary object of the present invention is to overcome the disadvantage of the conventional wireless keyboard that installs the linkage target search key.

To achieve the foregoing object, the present invention provides a wireless communication keyboard. It includes a key module and a wireless communication module. The key module has a plurality of keys each can be depressed by a user to output a keyboard command. The key module has a press combination including at least two keys depressible by the user at the same time to output a target search command. The wireless communication module is connected to the key module and receives the keyboard command and target search command, and has a linkage target setting state upon receiving the target search command to search a linkable information device within a linkage range.

In one embodiment the press combination includes a function switch key (Fn_Key) collaborated with a numeral key among the keys.

In another embodiment the press combination includes a function switch key (Fn_Key) collaborated with a character key among the keys.

In yet another embodiment the press combination includes a function switch key (Fn_Key) collaborated with a direction key among the keys.

In yet another embodiment the press combination includes a function switch key (Fn_Key) collaborated with a function key among the keys.

In yet another embodiment the key module includes a circuit board triggered by depression of the keys to output the keyboard command and target search command, a plurality of buffer support brackets located on the circuit board corresponding to the keys, and a keyboard baseboard located beneath the circuit board.

In yet another embodiment the keyboard has a keyboard housing to hold the key module. The keyboard baseboard is directly mounted onto the keyboard housing.

The invention also provides a method of establishing linkage for a wireless communication keyboard. The method includes the steps as follows:

Step 1: providing a wireless communication keyboard and setting a press combination with at least two keys of the keyboard that are depressible at the same time to output a target search command;

Step 2: pressing the keys of the press combination at the same time by a user to output the target search command to a wireless communication module; and

Step 3: receiving the target search command by the wireless communication module to enter a linkage target setting state to search a linkable information device within a linkage range.

In one embodiment the press combination a function switch key (Fn_Key) collaborated with a numeral key among the keys.

In another embodiment the press combination includes a function switch key (Fn_Key) collaborated with a function key among the keys.

By means of the structure set forth above, compared with the conventional keyboards, the keyboard of the invention provides features as follows:

1. Through the press combination, users can quickly search a linkable information device within a linkage range.

2. The keyboard structure is simplified, and the apertures needed and the corresponding structure can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the wireless communication keyboard according to the invention.

FIG. 2 is a sectional view of an embodiment of the wireless communication keyboard according to the invention.

FIG. 3 is a flowchart of the method of establishing linkage for a wireless communication keyboard according to the invention.

### DETAILED DESCRIPTION OF THE PREFERRED EMBODIMENTS

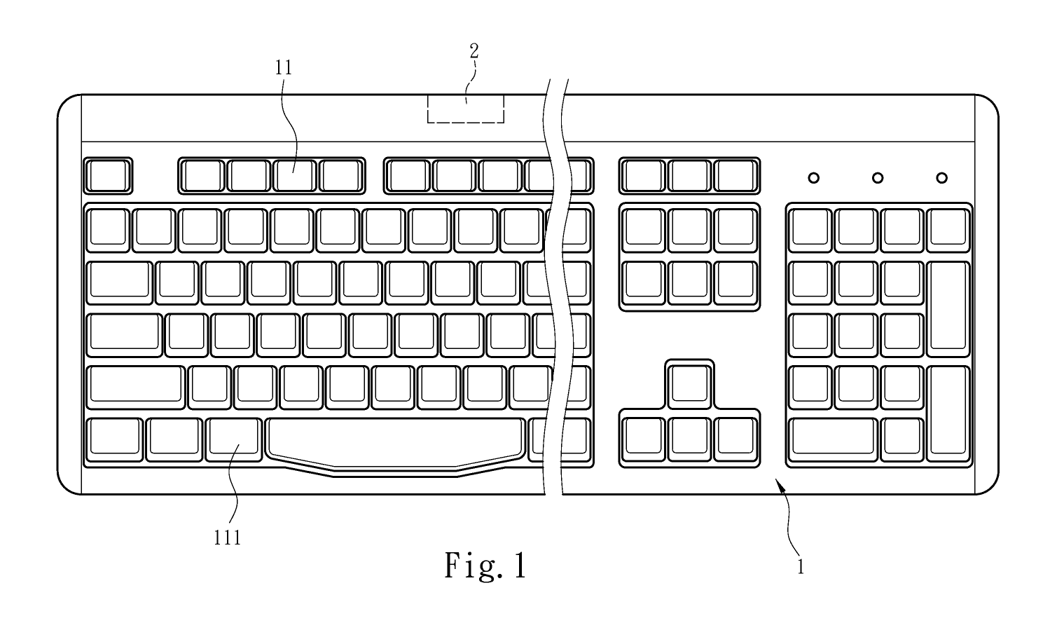

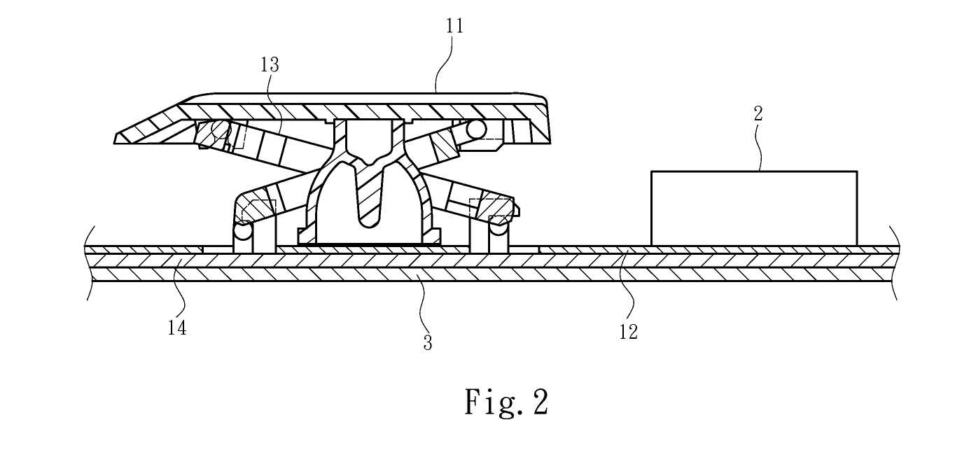

Please refer to FIGS. 1 and 2, the present invention aims to provide a wireless communication keyboard which includes a key module 1 and a wireless communication module 2. The key module 1 has a plurality of keys 11 each can be depressed by a user to output a keyboard command. The key module 1 also has a press combination including at least two keys depressible by the user at the same time to output a target search command. Furthermore, the key module 1 includes a circuit board 12 triggered by depression of the keys 11 to output the keyboard command and target search command, a plurality of buffer support brackets 13 located on the circuit board 12 corresponding to the keys 11, and a keyboard baseboard 14 located beneath the circuit board 12. The keyboard of the invention also has a keyboard housing 3 to hold the key module 1. The keyboard baseboard 14 is directly mounted onto the keyboard housing 3. The wireless communication module 2 is located in the key module 1 and connected to the circuit board 12 to receive the keyboard command and target search command output from the key module 1. The wireless communication module 2 has a linkage target setting state upon receiving the target search command to search a linkable information device within a linkage range. More specifically, the wireless communication module 2 can be a Bluetooth communication module. The linkage range can vary depending on different specification of the wireless communication module 2, hence no limitation is set herein.

More specifically, the press combination of the invention can be set in advance or by users by allocating at least two keys 11 depressed together at the same time to output the target search command. For instance, “numeral key 1” plus “numeral key 2”. When the set keys 11 of the press combination are depressed at the same time, the circuit board 12 outputs the target search command to drive the wireless communication module 2 to enter the linkage target setting state. The keys 11 of the press combination also can be a function switch key 111 (Fn_Key) collaborated with a numeral key, a character key, a direction key or a function key among the keys 11. The function key means F1 to F12 of the keys 11.

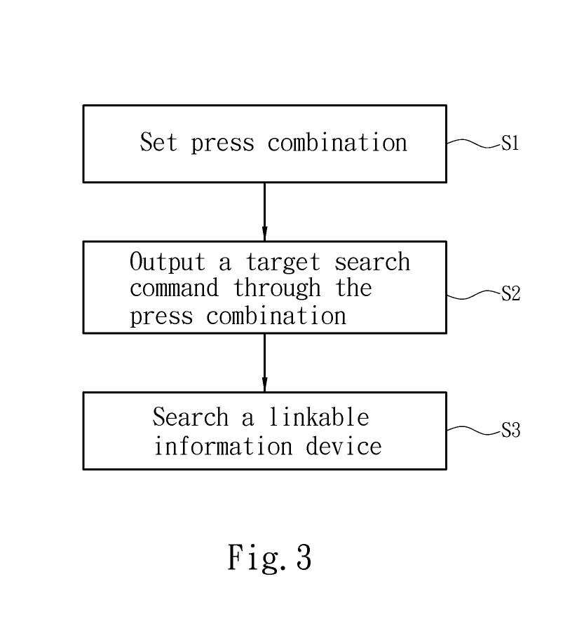

Please refer to FIG. 3, the invention also provides a method of establishing linkage for the wireless communication keyboard that comprises the steps as follows: Step S1: providing a wireless communication keyboard, and setting a press combination with at least two keys of the keyboard that are depressible at the same time to output a target search command; Step S2: pressing the keys of the press combination at the same time by a user to output the target search command to a wireless communication module; and Step S3: receiving the target search command by the wireless communication module to enter a linkage target setting state to search a linkable information device within a linkage range. More specifically, first, setting the press combination on the wireless communication keyboard to output the target search command; when the keyboard is in use, the keys 11 that form the press combination are depressed at the same time to output the target search command to the wireless communication module 2; when the wireless communication module 2 receives the target search command, it enters the linkage target setting state to search the linkable information device within the linkage range.

As a conclusion, the invention provides a wireless communication keyboard and a method of establishing linkage thereof. The wireless communication keyboard includes a key module and a wireless communication module. The key module has a plurality of keys each can be depressed by a user to output a keyboard command. The key module also has a press combination including at least two keys depressible by the user at the same time to output a target search command. The wireless communication module is connected to the key module to receive the keyboard command and target search command output from the key module. The wireless communication module has a linkage target setting state upon receiving the target search command to search a linkable information device within a linkage range. Thus users can quickly search the linkable information device through the press combination.

What is claimed:

1. A wireless communication keyboard, comprising:
a key module including a plurality of keys each being depressible by a user to output a keyboard command and a press combination including at least two keys depressible by the user at the same time to output a target search command; and
a wireless communication module which is connected to the key module to receive the keyboard command and the target search command output from the key module and includes a linkage target setting state upon receiving the target search command to search a linkable information device within a linkage range.

2. The wireless communication keyboard of claim 1, wherein the press combination includes a function switch key (Fn_Key) collaborated with a numeral key among the keys.

3. The wireless communication keyboard of claim 1, wherein the press combination includes a function switch key (Fn_Key) collaborated with a character key among the keys.

4. The wireless communication keyboard of claim 1, wherein the press combination includes a function switch key (Fn_Key) collaborated with a direction key among the keys.

5. The wireless communication keyboard of claim 1, wherein the press combination includes a function switch key (Fn_Key) collaborated with a function key among the keys.

6. The wireless communication keyboard of claim 1, wherein the key module includes a circuit board triggered by depression of the keys to output the keyboard command and the target search command, a plurality of buffer support brackets located on the circuit board corresponding to the keys, and a keyboard baseboard located beneath the circuit board.

7. The wireless communication keyboard of claim 6 further including a keyboard housing to hold the key module, and the keyboard baseboard being directly mounted on the keyboard housing.

8. A method of establishing linkage for a wireless communication keyboard, comprising the steps of:
Step 1: providing a wireless communication keyboard and setting a press combination with at least two keys of the keyboard that are depressible at the same time to output a target search command;
Step 2: pressing the keys of the press combination at the same time by a user to output the target search command to a wireless communication module; and
Step 3: receiving the target search command by the wireless communication module to enter a linkage target setting state to search a linkable information device within a linkage range.

9. The method of claim 8, wherein the press combination includes a function switch key (Fn_Key) collaborated with a numeral key among the keys.

10. The method of claim 8, wherein the press combination includes a function switch key (Fn_Key) collaborated with a function key among the keys.
